(19) United States
(12) Patent Application Publication
(10) Pub. No.: US 2004/0141096 A1
(43) Pub. Date: Jul. 22, 2004

(54) Flat display device with touch panel

(75) Inventor: Che-Kuei Mai, Hsinchu (TW)

Correspondence Address: LOWE HAUPTMAN GOPSTEIN GILMAN & BERNER, LLP, Suite 310, 1700 Diagonal Road, Alexandria, VA, 22314, US

(73) Assignee: Toppoly Optoelectronics Corp.

(21) Appl. No.: 10/347,603

(22) Filed: Jan. 22, 2003

(51) Int. Cl. G02F 1/1335; G09G 5/00

(52) U.S. Cl. 349/12; 345/173

(57) ABSTRACT

The upper polarizer of a flat display device is located on the upper transparent electrode of the touch panel that is combined with the flat display device. Therefore, the flat display device and the touch panel can share a glass or plastic substrate and a flexible printed circuit board substrate on the second electrode layer.

### BACKGROUND OF THE INVENTION

1. Field of the Invention

The invention relates to a flat display device with touch panel, more particularly to a liquid crystal display device with touch panel.

2. Description of the Prior Art

Liquid crystal display (LCD) device, which is a par flat display device, is a kind of household electric appliance in nowadays daily life, such as television or monitor of a computer, display device on a calculator, display screen of watch or mobile phone, display device of controlling system, or display panel of CD player. We often use a display screen with touch panel in our ordinary life, such as the introductions of famous scenery. Now it has been practically used in the industry that a touch panel is directly adhered on the upper transparent substrate when a flat display device with touch panel is needed. Such as Kaneda has disclosed the structure that a touch panel is directly adhered on the transmissive-type LCD device referred to the U.S. Pat. No. 6,411,344.

A conventional transmissive-type LCD device 100, as shown in FIG. 1, has a plane light guide plate 110 that is used to guide light rays from two light sources 112 at the two opposite ends of plane light guide plate 110 to light-emitting surface thereof and to LCD panel. There are many convex/concave dots on the bottom of plane light guide plate 110 in FIG. 1 to reflect light rays to the upper side. Another way for reflecting upward light rays is to utilize a plurality of slanted portions (V-cuts). A reflector 114 below the opposite surface of light-emitting surface of plane light guide plat 110 reflects all refracted downward light rays to the light-emitting surface thereof. A polarizer 116 and a lower substrate 118 are sequentially on the plane light guide plate 110. The material of conventional lower substrate 118 uses transparent glass, which thin film transistors (TFTs) 120 are directly formed thereon. A passivation layer 122 and transparent electrodes 124 are formed sequentially on the lower substrate 118 to form a lower plate of the LCD panel. Next, a color filter 130 and transparent electrodes 128 are formed sequentially on another transparent glass, which is upper substrate 132 of the LCD panel, to form upper plate of the LCD panel. Then, upper plate and lower plate are sealed with transparent electrodes 124, 128 face to face and vacuumed, and liquid crystal 126 is injected into the space between the upper and lower plates to form the LCD panel. Finally, a polarizer 136 is placed on the upper substrate 132 to form a transmissive-type LCD device 100.

The touch panel 102 has a lower transparent substrate 140 in FIG. 1, and a lower transparent electrode layer 142 are directly formed on the lower substrate 140. A upper transparent electrode layer 144 formed on a upper substrate 146 is combined with the lower transparent electrode layer 142 face to face. The method that presses the upper substrate 146 to contact the lower substrate 140 is used to detect the touch position. There is a polarizer 148 on the upper substrate 146.

However, Not only the thickness of whole display module are increased when a touch panel is directly adhered on the panel of LCD device, but also the transmission capacity of light rays is decreased. Besides, too many transparent glass substrates will cause the problems that the depth of focus is longer and the weight of display module is heavier.

### SUMMARY OF THE INVENTION

In the light of the state of the art described above, it is an object of the present invention to provide a transparent substrate used as the upper substrate of liquid crystal display (LCD) device and the lower substrate of touch panel is immune to the problems of the conventional flat display device with touch panel described above.

It is also an object of this invention to make the whole display module lighter and thinner.

It is another object of this invention to provide a flexible printed circuit board shared by LCD device and touch panel while the lower transparent electrode layer of touch panel is directly formed on the upper substrate of LCD device.

It is a further object of this invention to solve the problems that the depth of focus is too longer and the transmission capacity of the light rays is decreased.

It is still an object of this invention to decrease the energy loss of light rays that pass through the media of whole display module.

In view of the above and other objects which will become apparent as the description proceeds, there is provided according to a general aspect of the present invention a flat display device with touch panel which comprises a flat display device having a plane light source and a display panel with a lower substrate and an upper transparent substrate; and a touch panel on said upper transparent substrate including a first transparent electrode layer on said upper transparent substrate; a second transparent electrode layer on said first transparent electrode layer; a transparent plate on said second transparent electrode layer and a polarizer on said transparent plate.

Base on the idea described above, wherein said flat display device is a liquid crystal display device.

Base on the aforementioned idea, wherein said polarizer is shared by said liquid crystal display device and said touch panel.

Base on the idea described above, wherein said plane light source is a back light source.

Base on the aforementioned idea, wherein a flexible printed circuit board is shared by said liquid crystal display device and said touch panel.

In view of the above and other objects which will become apparent as the description proceeds, there is provided according to a general aspect of the present invention a liquid crystal display device with touch panel which comprises a LCD device having an upper transparent substrate and a polarizer; and a touch panel between said upper transparent substrate and said polarizer, wherein said upper transparent substrate is a lower electrode layer substrate of said touch panel.

Base on the idea described above, wherein said polarizer is on said upper transparent substrate of said touch panel.

Base on the aforementioned idea, wherein said polarizer is shared by said liquid crystal display device and said touch panel.

Base on the idea described above, wherein said liquid crystal display device comprises a back light source.

Base on the aforementioned idea, wherein a flexible printed circuit board is shared by said liquid crystal display device and said touch panel.

In view of the above and other objects which will become apparent as the description proceeds, there is provided according to a general aspect of the present invention a liquid crystal display device with touch panel which comprises a back light guide plate; a first polarizer on said back light guide plate; a first transparent substrate on said first polarizer; a plurality of thin film transistors on said first transparent substrate; a passivation layer on said first transparent substrate to cover said plurality of thin film transistors; a first transparent electrode layer on said passivation layer; a liquid crystal layer on said first transparent electrode layer; a second transparent electrode layer on said liquid crystal layer; a color filter on said second transparent electrode layer; a second transparent substrate on said color filter; a third transparent electrode layer on said second transparent substrate; a fourth transparent electrode layer on said third transparent electrode layer; a third transparent substrate on said fourth transparent electrode layer; and a second polarizer on said third transparent substrate.

Base on the idea described above, wherein said second polarizer is shared by said liquid crystal display device and said touch panel.

Base on the aforementioned idea, wherein a flexible printed circuit board is shared by said liquid crystal display device and said touch panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a view of conventional LCD device with touch panel;

FIG. 2 illustrates a view of LCD device with touch panel according to the first embodiment of this invention;

FIG. 3 illustrates a view of LCD device with touch panel according to the second embodiment of this invention; and

FIG. 4 illustrates a view of the flexible printed circuit board is shared by LCD device and touch panel according to the present invention.

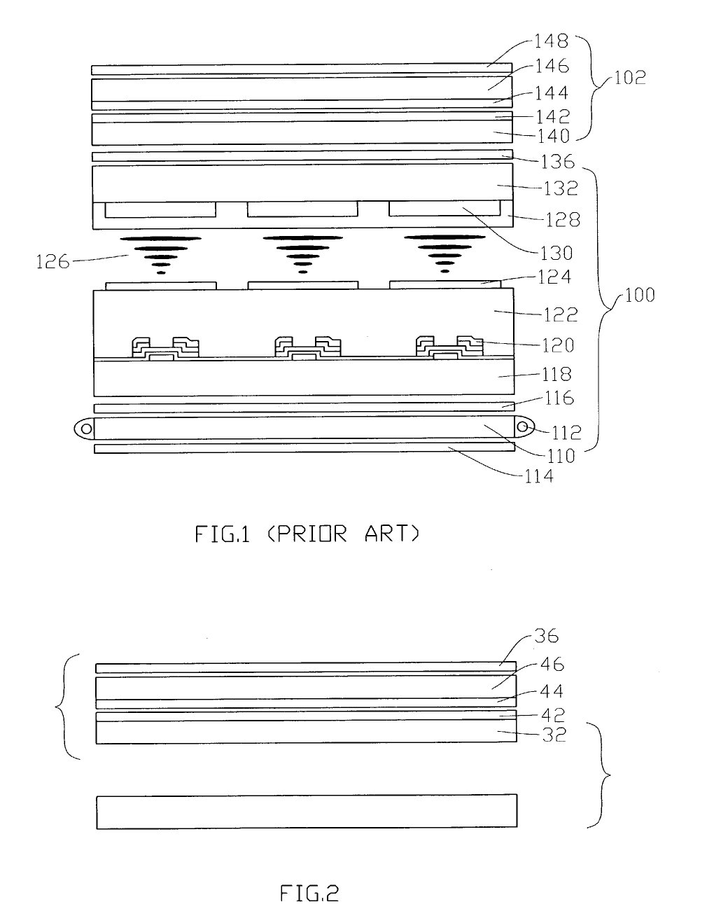

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

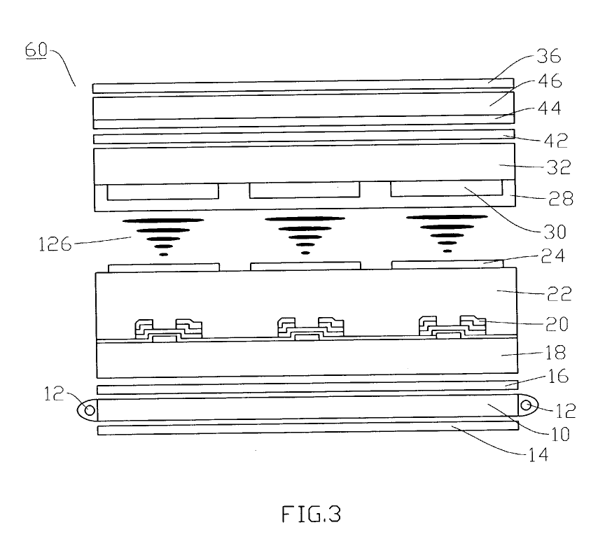

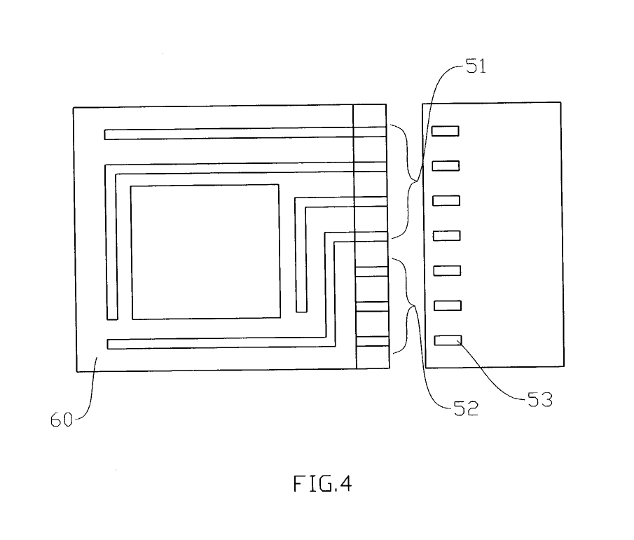

The first embodiment of this invention is illustrated in the top view of single pixel of FIG. 3 and in the cross-section view of the sub-pixel of FIG. 4. A single pixel 30 of the color LCD comprises three sub-pixels 31, 32, 33. The color of each sub-pixel is respectively red, green and blue color. It means if the sub-pixel 31 is the red sub-pixel, the sub-pixel 32 will be the green sub-pixel and the sub-pixel 33 will be the blue sub-pixel. As for the transflective-type LCD, each sub-pixel 31, 32, 33 can be divided into the transmissive area 312, 322, 332 and the reflective area 311, 321, 331.

FIG. 4 illustrates the cross-section view of the sub-pixel 31 comprises the transmissive area 312 and the reflective area 311. First, TFTs 401 are formed on the transparent substrate 41 and a transparent dielectric layer 402 is formed thereon subsequently. The transparent dielectric layer 402 can be a SiO₂ layer, a Si₃N₄ layer or a compound layer comprised of the above two materials. Then a color filter 42 having the thickness t1 is formed on each sub-pixel. The method for forming the color filter 42 is the same with the method of prior art. The color of color filter depends on the color of corresponding sub-pixel. For example, the sub-pixel 31 is red and the part of color filter 42 corresponding to the sub-pixel 31 is red. Equally, the sub-pixel 32 is green and the part of color filter 42 corresponding to the sub-pixel 32 is green. The sub-pixel 33 is blue and the part of color filter 42 corresponding to the sub-pixel 33 is blue. After the formation of the color filter 42, the transmissive area and the reflective area will be defined. The elevated reflective layer 43 with the bumps is formed at the reflective area. The material of elevated reflective layer 43 can be photopolymer or other opaque dielectric materials of which the thickness is about 1˜3 μm. If photopolymer is used as the material of elevated reflective layer, it can be coated on the whole color filter 42 first and elevated reflective layer can be made by using the lithography and etching processes. After the formation of the patterns of the transmissive area and the reflective area, the transmissive electrode 44 and the reflective electrode 45 should be formed. The transmissive electrode 44 at the transmissive area 312 that comprises ITO (indium tin oxide) or IZO (indium zinc oxide) is coated by using the sputter method and the reflective electrode 45 at the reflective area 311 that comprises Al, Ag or AlNd alloy is coated by using the sputter method. The transmissive electrode 44, the reflective electrode 45 and TFTs 401 are electrically connected each other.

Then the color filter 47 having the thickness t2 is formed on another transparent substrate 46 having many sub-pixels and each sub-pixel comprises the transmissive area and the reflective area. The method for forming the color filter 47 is the same with the method of prior art. The color of color filter depends on the color of corresponding sub-pixel. A common electrode 48 is formed on the color filter 47. Finally, the two transparent substrates are sealed with the color filters 42, 47 face to face and vacuumed, and liquid crystal is injected into the space between the two transparent substrates to form the liquid crystal layer 49.

The light rays in the reflective area 311 pass through the color filter 47 twice and the light rays in the transmissive area 312 pass through the color filter 42 and the color filter 47. Therefore, we can adjust the thickness t1 of color filter 42 and the thickness t2 of color filter 47 to generate the similar or same color saturation in the reflective area and the transmissive area while the transflective-type color LCD uses both of the transmissive and reflective display modes at the same time.

The second embodiment of this invention is illustrated in the top view of single pixel of FIG. 3 and in the cross-section view of the sub-pixel of FIG. 5, which illustrates the cross-section view of the sub-pixel 31 comprises the transmissive area 312 and the reflective area 311. First, TFTs 501 are formed on the transparent substrate 51 and a transparent dielectric layer 502 is formed thereon subsequently. The transparent dielectric layer 502 can be a SiO₂ layer, a Si₃N₄ layer or a compound layer comprised of the above two materials. Then a color filter 52 having the thickness t3 is formed on each sub-pixel. The method for forming the color filter 52 is the same with the method of prior art. The color of color filter depends on the color of corresponding sub-pixel. For example, the sub-pixel 31 is red and the part of color filter 52 corresponding to the sub-pixel 31 is red. Equally, the sub-pixel 52 is green and the part of color filter 52 corresponding to the sub-pixel 32 is green. The sub-pixel 33 is blue and the part of color filter 52 corresponding to the sub-pixel 33 is blue. It is the only difference between this and the first embodiment of FIG. 4 that there is not any the color filter 52 in the reflective area. After the formation of the color filter 52, the transmissive area and the reflective area will be defined. The elevated reflective layer 53 with the bumps is formed at the reflective area. The material of elevated reflective layer 53 can be photopolymer or other opaque dielectric materials of which the thickness is about 1˜3 μm. If photopolymer is used as the material of elevated reflective layer, it can be coated on the whole color filter 52 first and elevated reflective layer can be made by using the lithography and etching processes. After the formation of the patterns of the transmissive area and the reflective area, the transmissive electrode 54 and the reflective electrode 55 should be formed. The transmissive electrode 54 at the transmissive area 312 that comprises ITO (indium tin oxide) or IZO (indium zinc oxide) is coated by using the sputter method and the reflective electrode 55 at the reflective area 311 that comprises Al, Ag or AlNd alloy is coated by using the sputter method. The transmissive electrode 54, the reflective electrode 55 and TFTs 501 are electrically connected each other.

Then the color filter 57 having the thickness t4 is formed on another transparent substrate 56 having many sub-pixels and each sub-pixel comprises the transmissive area and the reflective area. The method for forming the color filter 57 is the same with the method of prior art. The color of color filter depends on the color of corresponding sub-pixel. A common electrode 58 is formed on the color filter 57. Finally, the two transparent substrates are sealed with the color filters 52, 57 face to face and vacuumed, and liquid crystal is injected into the space between the two transparent substrates to form the liquid crystal layer 59.

The light rays in the reflective area 311 pass through the color filter 57 twice and the light rays in the transmissive area 312 pass through the color filter 52 and the color filter 57. Therefore, we can adjust the thickness t3 of color filter 52 and the thickness t4 of color filter 57 to generate the similar or same color saturation in the reflective area and the transmissive area while the transflective-type color LCD uses both of the transmissive and reflective display modes at the same time.

Although the specific embodiment has been illustrated and described, it will be obvious to those skilled in the art that various modifications may be made without departing from what is intended to be limited solely by the appended claims.

What is claimed is:

1. A flat display device with touch panel, comprising:
a flat display device including:
a plane light source; and
a display panel with a lower substrate and an upper transparent substrate; and
a touch panel on said upper transparent substrate, including:
a first transparent electrode layer on said upper transparent substrate;
a second transparent electrode layer on said first transparent electrode layer;
a transparent plate on said second transparent electrode layer; and
a polarizer on said transparent plate.

2. The flat display device with touch panel according to claim 1, wherein said flat display device is a liquid crystal display device.

3. The flat display device with touch panel according to claim 2, wherein said polarizer is shared by said liquid crystal display device and said touch panel.

4. The flat display device with touch panel according to claim 2, wherein said plane light source is a back light source.

5. The flat display device with touch panel according to claim 4, wherein a flexible printed circuit board is shared by said liquid crystal display device and said touch panel.

6. A liquid crystal display device with touch panel, comprising:
a LCD device having an upper transparent substrate and a polarizer; and
a touch panel between said upper transparent substrate and said polarizer, wherein said upper transparent substrate is a lower electrode layer substrate of said touch panel.

7. The liquid crystal display device with touch panel according to claim 6, wherein said polarizer is on said upper transparent substrate of said touch panel.

8. The liquid crystal display device with touch panel according to claim 7, wherein said polarizer is shared by said liquid crystal display device and said touch panel.

9. The liquid crystal display device with touch panel according to claim 7, wherein said liquid crystal display device comprises a back light source.

10. The liquid crystal display device with touch panel according to claim 9, wherein a flexible printed circuit board is shared by said liquid crystal display device and said touch panel.

11. A liquid crystal display device with touch panel, comprising:
a back light guide plate;
a first polarizer on said back light guide plate;
a first transparent substrate on said first polarizer;
a plurality of thin film transistors on said first transparent substrate;
a passivation layer on said first transparent substrate to cover said plurality of thin film transistors;
a first transparent electrode layer on said passivation layer;
a liquid crystal layer on said first transparent electrode layer;
a second transparent electrode layer on said liquid crystal layer;
a color filter on said second transparent electrode layer;
a second transparent substrate on said color filter;
a third transparent electrode layer on said second transparent substrate;
a fourth transparent electrode layer on said third transparent electrode layer;
a third transparent substrate on said fourth transparent electrode layer; and
a second polarizer on said third transparent substrate.

12. The liquid crystal display device with touch panel according to claim 11, wherein said second polarizer is shared by said liquid crystal display device and said touch panel.

13. The liquid crystal display device with touch panel according to claim 11, wherein a flexible printed circuit board is shared by said liquid crystal display device and said touch panel.
